(19) United States
(12) Patent Application Publication
(10) Pub. No.: US 2003/0229511 A1
(43) Pub. Date: Dec. 11, 2003

(54) Method, system, and storage medium for providing lead services over a computer network

(76) Inventors: John Edmondson, Phoenix, AZ (US); R. Michael Elder, Longmeadow, MA (US); David S. McBride, Scottsdale, AZ (US)

Correspondence Address: Philmore H. Colburn II, CANTOR COLBURN LLP, 55 Griffin Road South, Bloomfield, CT, 06002, US

(21) Appl. No.: 10/460,567

(22) Filed: Jun. 11, 2003

Related U.S. Application Data
(60) Provisional application No. 60/387,650, filed on Jun. 11, 2002.

(51) Int. Cl. G06F 17/60

(52) U.S. Cl. 705/1; 705/26

(57) ABSTRACT

An exemplary embodiment of the invention relates to a method, system, and storage medium for providing lead services by a host system over a computer network. The method comprises receiving a referral for a lead from a networker; generating a lead alert message using information provided in the referral, the lead alert message comprising minimal information about the lead; associating the lead with at least one client; and transmitting the lead alert message to the client along with an invitation to accept the lead. The invitation includes a time for acceptance. Upon acceptance of the lead by a client, the host system provides access to comprehensive information about the lead. The lead describes a need for products or services by a purchasing entity. The method further comprises disseminating the lead alert message to an alternative client upon at least one of: a rejection of the lead alert message the client; a failure to respond to the invitation within the time limit; and upon a failure to negotiate a sale subsequent to obtaining the comprehensive information about the lead. The invention also includes a system and a storage medium.

### CROSS-REFERENCE TO RELATED APPLICATIONS

This application claims the benefit of U.S. provisional application serial No. 60/387,650 filed Jun. 11, 2002, the entire contents of which are incorporated herein by reference.

### BACKGROUND

This invention relates generally to lead management, and more particularly, the present invention relates to a method, system, and storage medium for providing lead services in a business-to-business sales environment.

The use of third party providers to enhance the selling process is a common and accepted practice. For example, hand-held device manufacturers such as Palm™ and Hewlett-Packard™ enhance their marketing efforts with “outside marketing firms” to serve as company salesmen in national retail environments. Microsoft™ and Handspring™, among others, utilize third party “influencer” networks to expand reach efforts. Influencer networks comprise individuals who utilize a variety of means (e.g., print medium and interviews) to help influence the purchase decision of a specific target market. Additionally, companies such as Compaq™ and Intel™ have instituted formal referral programs, whereby individuals can provide leads in exchange for a posted commission. These types of programs, however, are lacking in the ability to effectively allocate resources and track efforts. Leads are generally gathered and distributed in a haphazard and informal way by many sales professionals which can be inefficient and waste valuable time. Further, existing lead services do not provide qualified leads but generally comprise lists of companies that require additional and continuing prospecting in order to obtain a sale.

What is needed is a centralized approach to gathering, qualifying, distributing, and managing known leads and referrals in a sales environment.

### SUMMARY

An exemplary embodiment of the invention relates to a method, system, and storage medium for providing lead services by a host system over a computer network. The method comprises of receiving a referral for a lead from a networker; generating a lead alert message using information provided in the referral, the lead alert message comprising minimal information about the lead; offering the lead to at least one client; and transmitting the lead alert message to the client along with an invitation to accept the lead. The invitation includes a time for acceptance. Upon acceptance of the lead by a client, the host system provides access to comprehensive information about the lead. The lead describes a need for products or services by a purchasing entity. The method further comprises of disseminating the lead alert message to an alternative client upon at least one of: a rejection of the lead alert message the client; a failure to respond to the invitation within the time limit; and upon a failure to negotiate a sale subsequent to obtaining the comprehensive information about the lead. The invention also includes a system and a storage medium.

### BRIEF DESCRIPTION OF THE DRAWINGS

Referring now to the drawings wherein like elements are numbered alike in the several FIGURES:

FIG. 1 is a block diagram of a portion of an exemplary network system upon which the lead services tool may be implemented;

FIG. 2 is a flowchart describing a process for implementing the features and functions of the lead services tool in an exemplary embodiment;

FIG. 3 is a sample computer screen window illustrating a lead alert message as seen by a client system that has been selected to receive the lead alert message;

FIG. 4 is a sample computer screen window illustrating a lead services login page as seen by a client system;

FIG. 5 is a sample computer screen window illustrating a lead acceptance page as seen by a client system;

FIG. 6 is a sample computer screen window illustrating a lead acceptance page along with a ‘terms and conditions’ subwindow as seen by a client system; and

FIG. 7 is a sample computer screen window illustrating specific lead details provided to a client system in response to an acceptance of the lead alert message.

### DETAILED DESCRIPTION OF THE PREFERRED EMBODIMENT

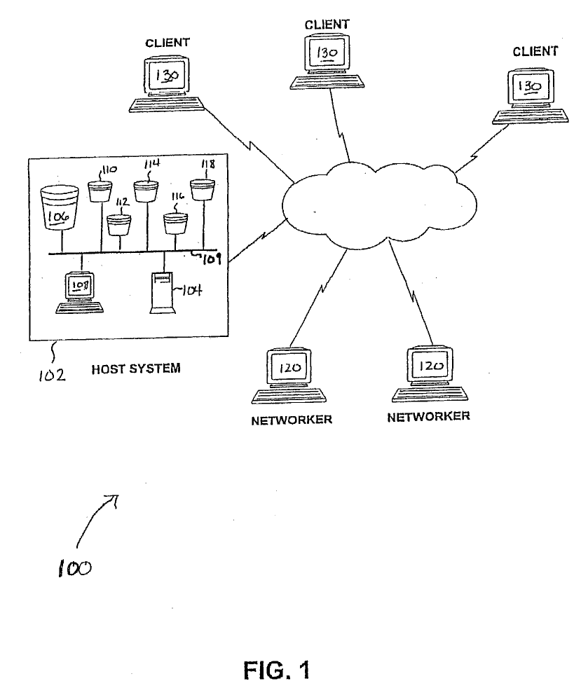

In an exemplary embodiment, the lead services tool is implemented via a computer network system such as system 100 of FIG. 1. System 100 comprises a host system 102 which executes the lead services tool described herein. Host system 102 includes a server 104 coupled to a data storage device 106 and a workstation 108. Server 104 includes enterprise applications software typically found in a business enterprise such as web server software, word processing, billing, database management, groupware, email, security, encryption, in addition to the lead services tool of the invention. Host system 102 preferably includes a workflow application for tracking lead service activities as described further herein, although some or all of the tracking and workflow may be performed manually. Further, host system 102 includes a user interface for facilitating communications between itself and outside entities.

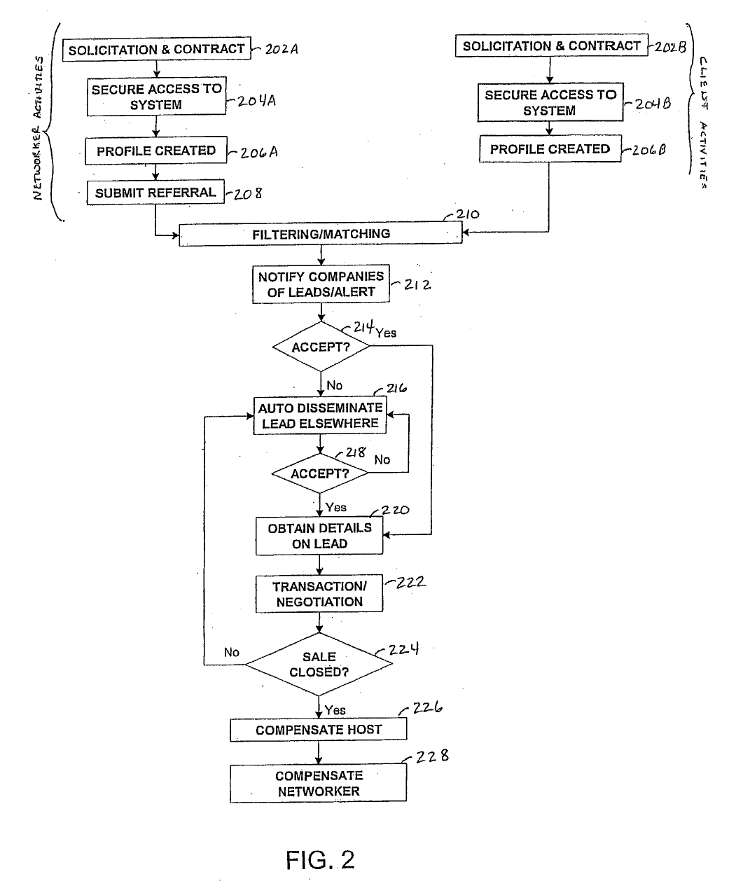

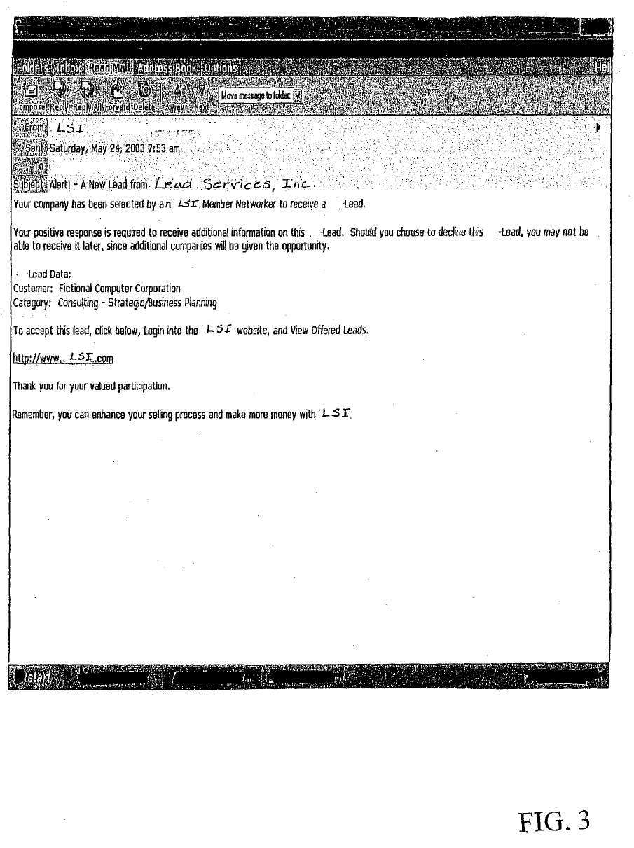

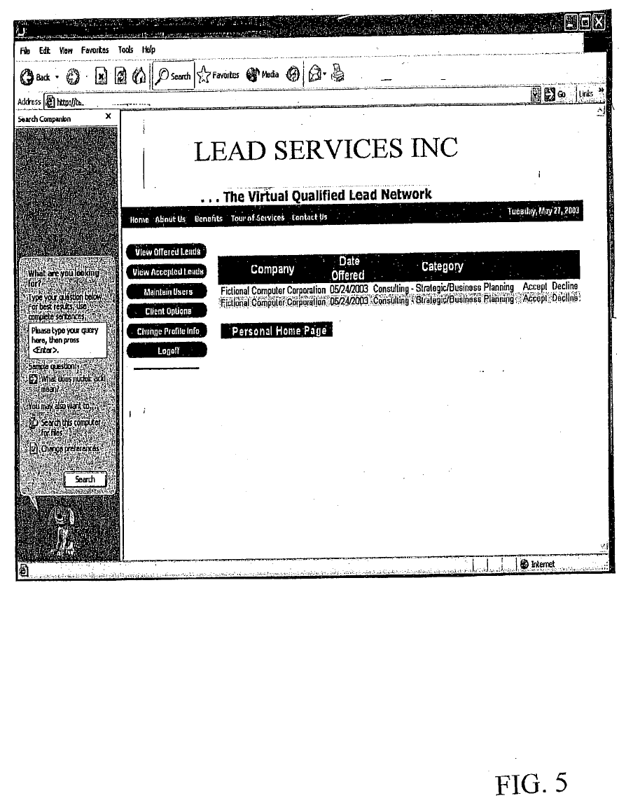

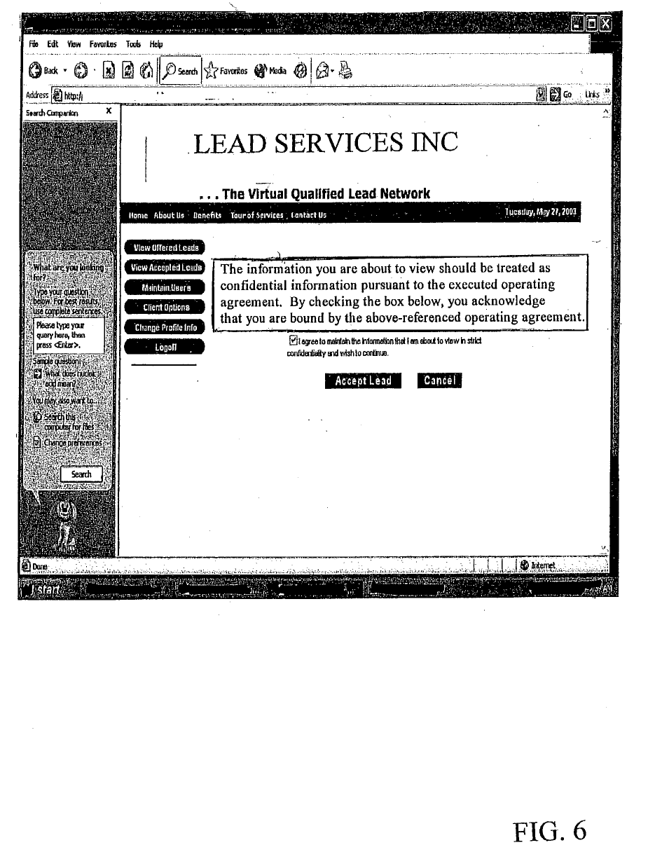

In an exemplary embodiment, the lead services tool is executed via host system 102 although some or all of the tasks may be shared or provided by a third party provider system (not shown) in order to realize the advantages of the invention. For example, a third party provider could be an application service provider (ASP) or other similar entity. Data storage device 106 stores databases of information used by host system 102 including networker accounts database 110, lead alerts database 112, client accounts database 114, comprehensive alerts database 116 and alert tracking database 118. Types of data stored in databases 110-116 will be described in the context of the method steps provided in FIG. 2 as well as the depictions represented in FIGS. 3-8. Data storage device 106 may comprise of any form of mass storage device configured to read and write database type data maintained in a file store and is logically addressable as a consolidated data source across system 100. Information stored in data storage device 106 is retrieved and manipulated via server 104.

It will be understood that more than one server may be utilized by host system 102 in order to accommodate high volume lead activities as described further herein. Further, data storage device 106 and server 104 may comprise a single unit, such as, for example, a mainframe computer. Communications among server 104, data storage device 106 and workstation 108 may be accomplished by any suitable networking infrastructure known in the art including wireless technology, radio-based communications, telephony-based communications, or a combination of the above. For purposes of illustration, however, the networking infrastructure employed by host system 102 is an Intranet 109. Workstation 108 may be any general-purpose computer device such as a personal computer or laptop with a computer processor, display device, and suitable input/output devices such as a mouse, keyboard, printer, etc. Workstation 108 may be accessed by authorized users of host system 102 such as customer service personnel, sales personnel, and system administrators in order to process the activities described herein with respect to the features and functions of the tool. Although one workstation 108 is shown, any number of workstations may be utilized by host system 102.

Networking systems 120 and client systems 130 may include any communication process to connect to host system 102 currently embodied by web browser software and an Internet service connection. Users of networking systems 120 are referred to herein as ‘networkers’ and are described further herein.

Client systems 130 represent businesses or organizations targeted by host system 102 as candidates for referrals or leads based upon their industry and business needs. Users of client systems 130 include individuals or representatives of client systems 130 authorized to conduct business with host system 102. Client systems 130, as subscribing entities of the lead services tool, are able to access qualified leads via host system 102.

Host system 102 may communicate with networking systems 120 and client systems 130 via the Internet as well as other, traditional or non-traditional communication channels.

Host system 102 provides qualified leads and referrals as a service, whereby client systems 130 receive detailed leads based upon input from a network of experienced outside sales professionals via one or more of networker systems 120. These experienced outside sales professionals are referred to herein as ‘networkers’. Networkers provide information to host system 102 of unfulfilled customer needs. Networkers have significant ability to garner detailed needs of businesses in the course of their job functions. For example, suppose a networker (who is also a sales professional for a pharmaceutical company) is involved in a sales transaction at a hospital. During a conversation with a contact from the hospital, the sales professional learns incidentally that the hospital is planning to expand one of its wings sometime within the next six months. The networker learns from the contact that four-dozen beds will be added to this wing. The networker would submit this information to host system 102 in the form of a referral/lead. This information would then be expressed as a lead alert message as described further in FIG. 2.

The process of procuring and disseminating leads is provided in FIG. 2. The processes described herein with respect to FIG. 2 are preferably tracked and monitored by a workflow/ tracking component of host system 102. In a preferred embodiment, networking systems 120 and client companies such as client systems 130 are solicited to contract with host system 102 to accept and use the lead services provided by host system 102 at steps 202A and 202B respectively. Although not necessary to realize the advantages of the invention, incentives to subscribe may be offered to both networking systems 120 and client systems 130 if desired by host system 102 such as useful and relevant business information and downloadable applications provided via its web site. Other value-added services may be offered through host system 102. For example, host system 102 may partner with leading companies to post links to respective partners and to incorporate valuable content within host system 102.

A networker secures access to the host system 102 at step 204A and a profile is created via the lead services tool which includes personal and relevant information concerning the networker at step 206A. This profile is stored in networker accounts database 110. The networker may then submit one or more referrals for leads based upon information from a variety of sources (at step 208), including: a trade show, a conversation with an existing/prospective customer (as described above) or colleague, sales conferences, and other similar events. Referral information provided by the networker may include, but is not limited to, a company name for the lead, division, contact name, telephone and email, contact title, business description, and lead opportunity description. The subject of the referral information is referred to herein as a ‘purchasing entity’. A portion of the information relating to the purchasing entity's needs is stored as a lead alert message in lead alerts database 112 and represents generalized information about the purchasing entity. A more detailed version of the information is stored as a comprehensive lead message in comprehensive lead database 116.

In a manner similar to that described with respect to steps 202A-206A, a representative of client system 130 is solicited by host system 102 to use the services provided by the lead services tool at step 202B. The client system 130 representative secures access to host system 102 at step 204B and creates a profile that details the company's product and service offerings, contact information, preferences for lead alert message notification, and commission rate for all transactions originated from leads at step 206B. This information is stored in client accounts database 114. Commissions are paid by client systems 130 to host system 102 which, in turn, compensates the networker responsible for submitting the lead that results in a sale. In a preferred embodiment, these client systems are contractually bound to respond to leads in a timely fashion and to pay host system 102 their stated commission for all sale closings that originate from leads. Host system 102 will avail each client system's respective service offering(s) and commission structure to networkers, who will be given the option of selecting client systems to receive the lead. This can provide incentive among client companies to post competitive commissions; thus, driving up revenue for networkers. If a networker opts not to select a client system to receive the lead, the lead services tool may automatically and randomly disseminate the lead to other relevant client systems in the market space. A specified number of client systems are preferably established as a limit for which leads will be sent during any given time period. This can be accomplished via a filtering/matching function executed by the lead services tool at step 210.

The lead services tool notifies client systems of leads via a lead alert message (shown generally in FIG. 3), utilizing a preferred mode of dissemination as indicated in the client profile at step 212. As stated above, the lead alert message presents minimal information, such as the purchasing entity's name and division. Client systems will have a specified number of business days to accept/reject any lead at step 214. These and other time constraints may be tracked and monitored by a workflow/tracking component of host system 102. Such applications are generally known and appreciated by those skilled in the art. It is conceivable that a lead alert message may be accepted by any number of recipient client systems targeted to receive the alert message. It is also conceivable that none of the recipient client systems may accept. Any rejected lead, or those not overtly accepted within the required time, may be presented to other relevant client systems within the relevant market via the lead services tool at step 216. For example, if six client systems are targeted to receive a lead alert message, but only one client system accepts the lead, the lead services tool may be configured to select one or more additional (also referred to as secondary) client systems to receive the lead. The client system that first accepted the lead alert message would have the benefit of being first in time to pursue the lead.

These secondary client systems have the opportunity to reject the lead also (step 218), in which case the process may then return to step 216 depending upon the business rules adopted via the lead services tool. Similar time constraints are preferably imposed on these secondary client systems as well.

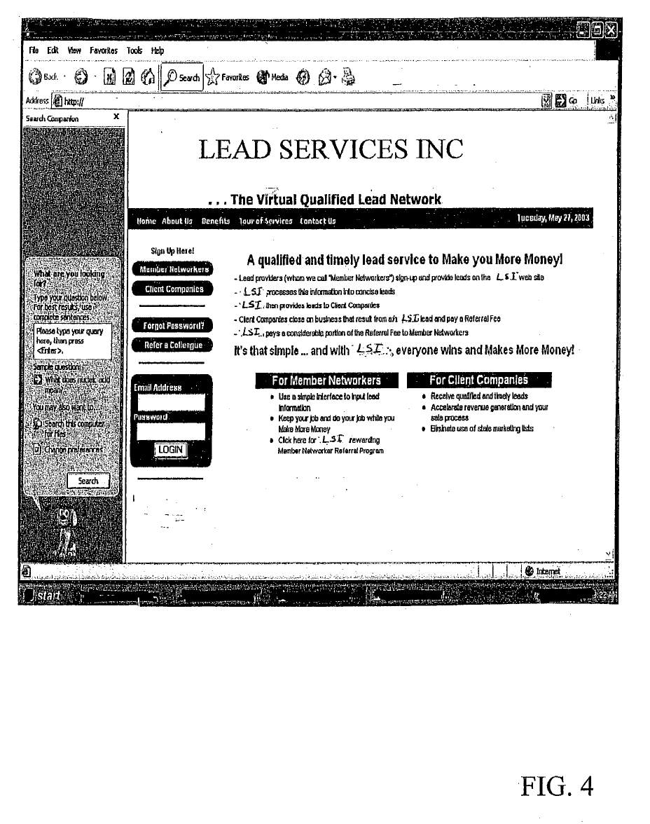

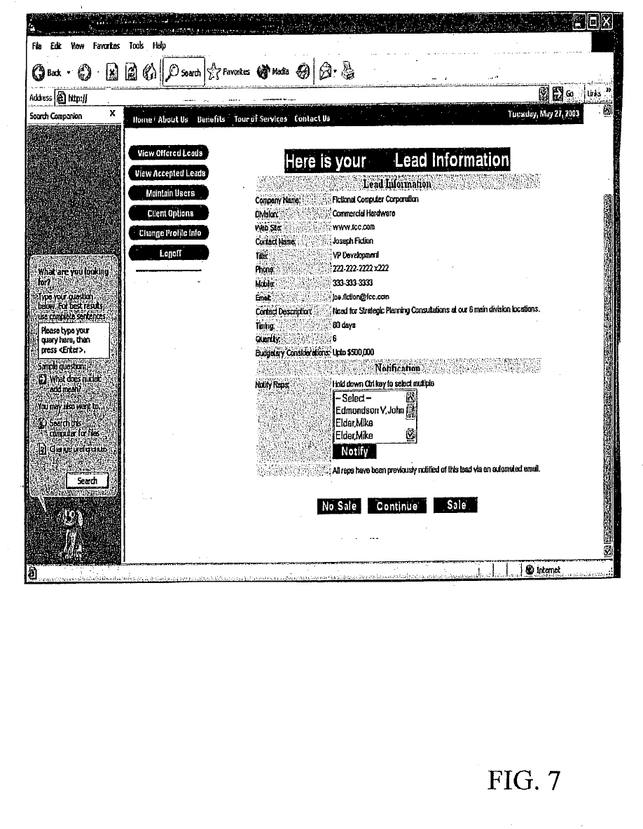

Once a lead alert message has been accepted, by way of step 214 or 218, the recipient client system enters a password-protected page (shown generally in FIGS. 4-7) on host system 102 to obtain more details at step 220. This detailed information is referred to as a comprehensive lead message. A sample comprehensive lead message is shown in FIG. 7. By accepting the lead alert message, the client system agrees to engage in negotiations between the client system and the purchasing entity at step 222 potentially resulting in a sale at step 224. If the parties do not close the sale, the process may revert back to 216 whereby the lead is disseminated to other client systems subject to company business protocol. For example, suppose that a purchasing entity received an invitation to negotiate with two recipient client systems and selects the first client system. Suppose further that a sale does not result from these negotiations and that the purchasing entity opts to negotiate with the second client system resulting in a sale. In this scenario, it clearly would not be necessary to cause further dissemination of the lead alert message. However, if a sale does not result from these negotiations, the lead alert message may be distributed to additional client systems.

Once a sale is consummated and the transaction from the lead closes at step 224, host system 102 receives the pre-established compensation for the lead within a specified period of time (e.g., within 30 days of closing) at step 226. Host system 102 then compensates the networker who provided the lead upon receipt of payment from the client company at step 228.

Lead activities conducted throughout the processes described above are preferably monitored and random audits may be performed to ensure compliance. Client companies found not in compliance may be charged a ‘fee’ and repeat offenders may be banned from the site. The referral network also monitors lead submissions, to ensure that a networker does not flood the system with ‘lists’ of names merely as a fishing expedition. Networkers that are found to abuse the system may be banned from the site.

It will be understood that the steps recited in FIG. 2 with respect to networker activities (steps 202A-206A) may be performed earlier, synchronously, or subsequent to the steps recited with respect to client system activities (steps 202B-206B). The order of the steps recited is meant for illustrative purposes and is not to be construed as limiting in scope.

As described above, the present invention can be embodied in the form of computer-implemented processes and apparatuses for practicing those processes. The present invention can also be embodied in the form of computer program code, including but not limited to source and object code, containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for providing lead services by a host system comprising:
receiving a referral for a lead from a networker;
generating a lead alert message using information provided in said referral, said lead alert message comprising minimal information about said lead;
associating said lead with at least one client;
transmitting said lead alert message to said at least one client along with an invitation to accept said lead, said invitation including a time for acceptance; and
upon acceptance of said lead by a client, providing access to comprehensive information about said lead;
wherein said lead describes a need for products or services by a purchasing entity.

2. The method of claim 1, further comprising:
disseminating said lead alert message to an alternative client upon at least one of:
a rejection of said lead alert message by said at least one client;
a failure to respond to said invitation within said time limit by said at least one client; and
upon a failure to negotiate a sale subsequent to obtaining said comprehensive information about said lead.

3. The method of claim 2, further comprising:
upon closing a sale between said networker and said purchasing entity, providing compensation to said networker and individuals of said host system for said lead services.

4. The method of claim 3, further comprising:
tracking progress of said lead services via a workflow application.

5. The method of claim 1, wherein said networker selects a client to receive said lead alert message.

6. The method of claim 1, wherein a limit to a quantity of clients is established for which said lead alert message is transmitted, said clients selected by a filtering function that matches purchasing entity needs to client offerings.

7. The method of claim 1, wherein said minimal information about said lead includes a purchasing entity's name.

8. The method of claim 1, wherein said comprehensive information about said lead may include but may not be limited to at least one of a purchasing entity's:
name;
division;
contact name;
contact title;
contact telephone;
contact email;
contact website;
lead opportunity description, said lead opportunity description including a product or service desired by said purchasing entity;
timing;
quantity; and
budgetary considerations.

9. The method of claim 1, further comprising:
establishing a networker profile for said networker, said networker profile comprising personal and contact data for said networker and at least one referral.

10. The method of claim 1, further comprising:
establishing a client profile, comprising:
client product and service offerings;
client contact information;
client preferences for lead alert message notification; and
commission rate for transactions originating from leads; and
providing access to client profile information to said networker.

11. A storage medium encoded with machine-readable computer program code for providing lead services by a host system, said storage medium including instructions for causing a computer to implement a method, comprising:
receiving a referral for a lead from a networker;
generating a lead alert message using information provided in said referral, said lead alert message comprising minimal information about said lead;
associating said lead with at least one client;
transmitting said lead alert message to said at least one client along with an invitation to accept said lead, said invitation including a time for acceptance; and
upon acceptance of said lead by a client, providing access to comprehensive information about said lead;
wherein said lead describes a need for products or services by a purchasing entity.

12. The storage medium of claim 11, further comprising instructions for causing said computer to implement:
disseminating said lead alert message to an alternative client upon at least one of:
a rejection of said lead alert message by said at least one client;
a failure to respond to said invitation within said time limit by said at least one client; and
upon a failure to negotiate a sale subsequent to obtaining said comprehensive information about said lead.

13. The storage medium of claim 12, further comprising instructions for causing said computer to implement:
upon closing a sale between said networker and said purchasing entity, providing compensation to said networker and individuals of said host system for said lead services.

14. The storage medium of claim 13, further comprising instructions for causing said computer to implement:
tracking progress of said lead services via a workflow application.

15. The storage medium of claim 11, wherein said networker selects a client to receive said lead alert message.

16. The storage medium of claim 11, wherein a limit to a quantity of clients is established for which said lead alert message is transmitted, said clients selected by a filtering function that matches purchasing entity needs to client offerings.

17. The storage medium of claim 11, wherein said minimal information about said lead includes a purchasing entity's name.

18. The storage medium of claim 11, wherein said comprehensive information about said lead may include but may not be limited to one of a purchasing entity's:
name;
division;
contact name;
contact title;
contact telephone;
contact email;
contact website;
lead opportunity description, said lead opportunity description including a product or service desired by said purchasing entity;
timing;
quantity; and
budgetary considerations.

19. The storage medium of claim 11, further comprising instructions for causing said computer to implement:
establishing a networker profile for said networker, said networker profile comprising personal and contact data for said networker and at least one referral.

20. The storage medium of claim 11, further comprising instructions for causing said computer to implement:
establishing a client profile, comprising:
client product and service offerings;
client contact information;
client preferences for lead alert message notification; and
commission rate for transactions originating from leads; and
providing access to client profile information to said networker.

21. A system for providing lead services, comprising:
a host system, including:
a server executing a workflow application;
a data storage device coupled to said server via said network;
a workstation coupled to said server via said network;
a lead services tool executed on said server, said lead services tool including a user interface;
at least one networking system; and
at least one client system;
wherein said lead services tool performs:
receiving a referral for a lead from a networker at said at least one networking system;
generating a lead alert message using information provided in said referral, said lead alert message comprising minimal information about said lead;
associating said lead with at least one client;
transmitting said lead alert message to said at least one client at said at least one client system along with an invitation to accept said lead, said invitation including a time for acceptance; and upon acceptance of said lead by a client, providing access to comprehensive information about said lead; and
wherein further said lead describes a need for products or services by a purchasing entity.

22. The system of claim 21, wherein said lead services tool further performs:
disseminating said lead alert message to an alternative client upon at least one of:
a rejection of said lead alert message by said at least one client;
a failure to respond to said invitation within said time limit by said at least one client; and
upon a failure to negotiate a sale subsequent to obtaining said comprehensive information about said lead.

23. The system of claim 21, wherein said data storage device stores:
a networker database comprising networker profiles and referrals;
a lead alerts database;
a client accounts database comprising client profiles;
a comprehensive alerts database; and
an alert tracking database.
